(19) United States
(12) Patent Application Publication
(10) Pub. No.: US 2025/0299378 A1
(43) Pub. Date: Sep. 25, 2025

(54) PARTIALLY DISPLAY-LOCKED VIRTUAL OBJECTS

(71) Applicant: SpaceCraft, Inc., Beverly Hills, CA (US)

(72) Inventors: Ian M. Richter, Los Angeles, CA (US); Alexis R. Haraux, Seattle, WA (US)

(21) Appl. No.: 18/615,387

(22) Filed: Mar. 25, 2024

Related U.S. Application Data
(60) Provisional application No. 63/453,995, filed on Mar. 22, 2023.

(51) Int. Cl. G06T 11/00; G06T 7/70; G06T 13/00

(52) U.S. Cl. CPC G06T 11/00; G06T 7/70; G06T 13/00

(57) ABSTRACT

In one implementation, a method of displaying a virtual object is performed at a device with a display, one or more processors, and non-transitory memory. The method includes determining a first display location in a two-dimensional display coordinate system for a first portion of a virtual object. The method includes detecting an object at an object location in a three-dimensional world coordinate system. The method includes determining, based on the object location, a first world location in the three-dimensional world coordinate system for a second portion of the virtual object. The method includes determining a second display location in the two-dimensional display coordinate system for the second portion of the virtual object based on the first world-location in the three-dimensional world coordinate system and a first pose of the device. The method includes displaying, on the display, the virtual object, wherein the first portion is displayed at the first display location and the second portion is displayed at the second display location.

### CROSS-REFERENCE TO RELATED APPLICATIONS

This application claims priority to U.S. Provisional Patent App. No. 63/453,995, filed on Mar. 22, 2023, which is hereby incorporated by reference in its entirety.

### TECHNICAL FIELD

The present disclosure generally relates to displaying virtual content.

### BACKGROUND

Virtual objects can be displayed, by a display of a device, in a mixed reality (MR) environment based on a physical environment. In various implementations, a virtual object is a display-locked virtual object that, in response to movement of the device in the real environment, maintains its location of the display. In various implementations, a virtual object is a world-locked virtual object that, in response to movement of the device in the physical environment, changes its location on the display to maintain its appearance at the same location in the physical environment.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1N illustrate a physical environment at a series of times.

FIG. 2 illustrates a flowchart representation of a method of displaying a virtual object in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying virtual content. In various implementations, the method is performed at a device with a display, one or more processors, and non-transitory memory. The method includes determining a first display location in a two-dimensional display coordinate system for a first portion of a virtual object. The method includes detecting an object at an object location in a three-dimensional world coordinate system. The method includes determining, based on the object location, a first world location in the three-dimensional world coordinate system for a second portion of the virtual object. The method includes determining a second display location in the two-dimensional display coordinate system for the second portion of the virtual object based on the first world-location in the three-dimensional world coordinate system and a first pose of the device. The method includes displaying, on the display, the virtual object, wherein the first portion is displayed at the first display location and the second portion is displayed at the second display location.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

As noted above, virtual objects can be display-locked or world-locked. However, in various implementations, a virtual object can be partially display-locked and partially world-locked. For example, a first portion of the virtual object is display-locked and a second portion of the virtual object is world-locked.

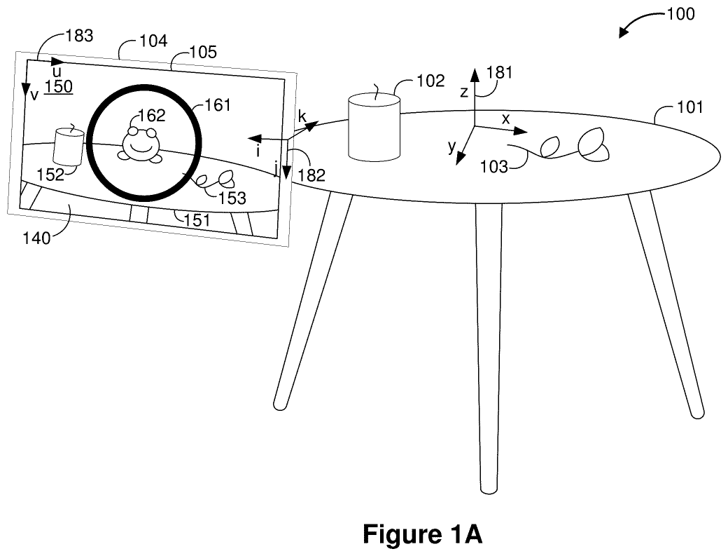

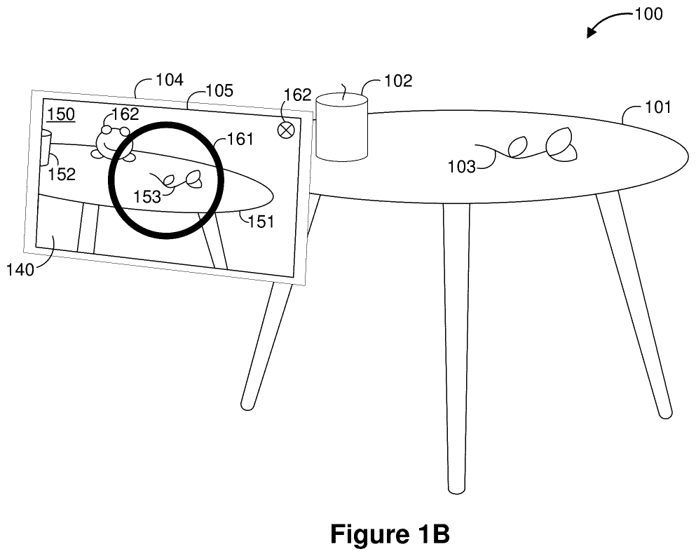

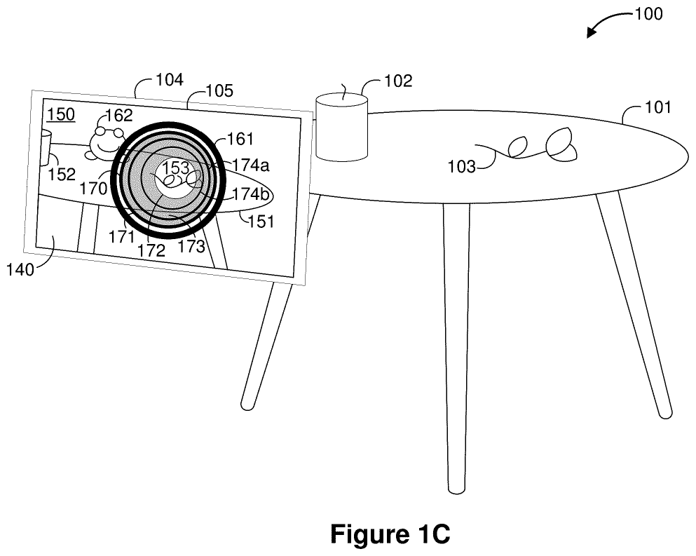

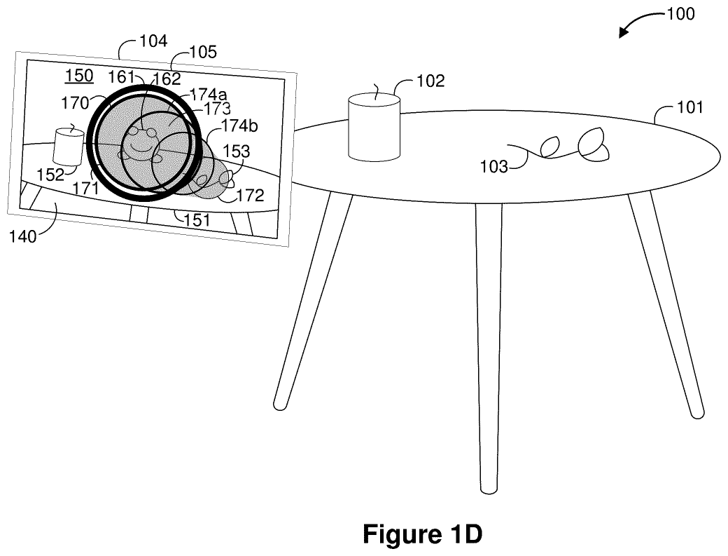

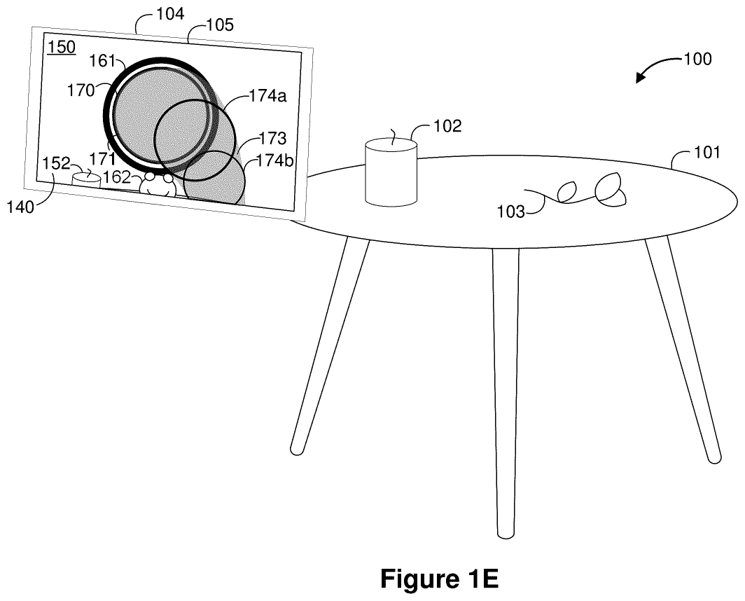

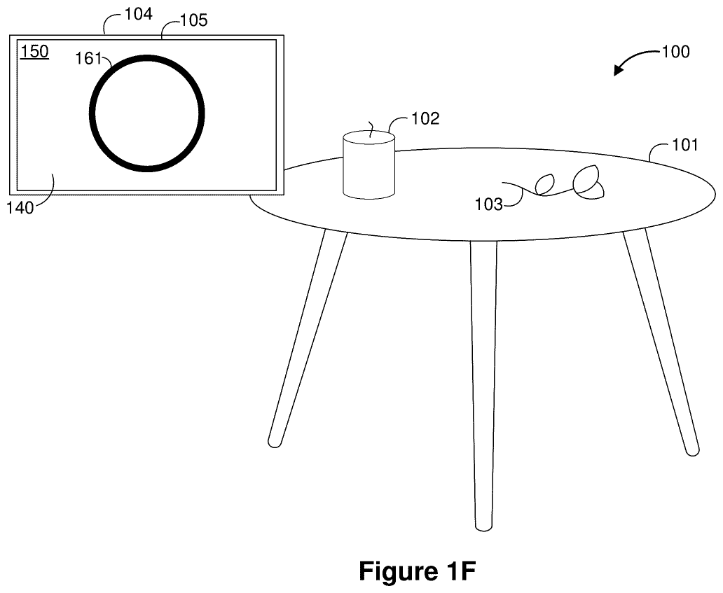

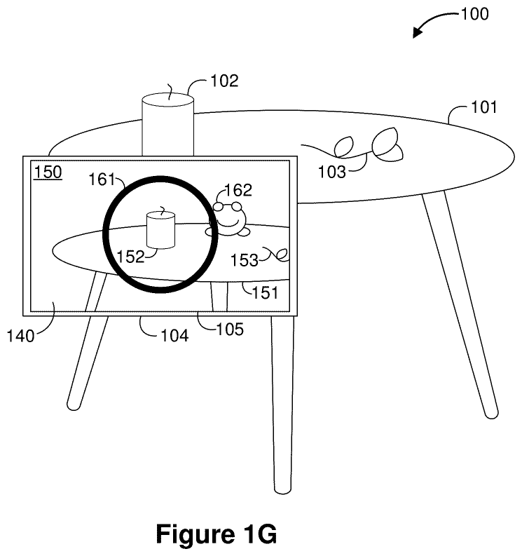

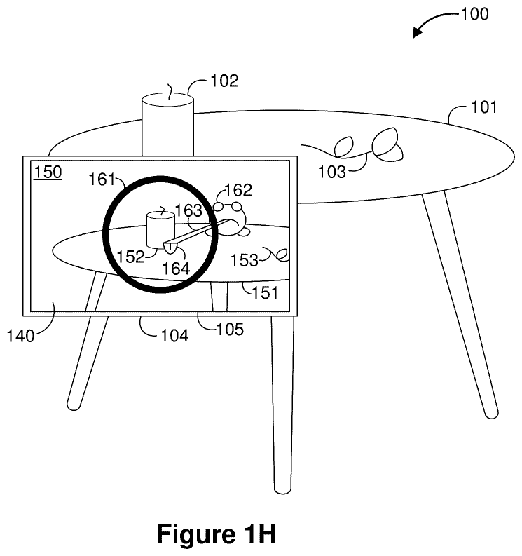

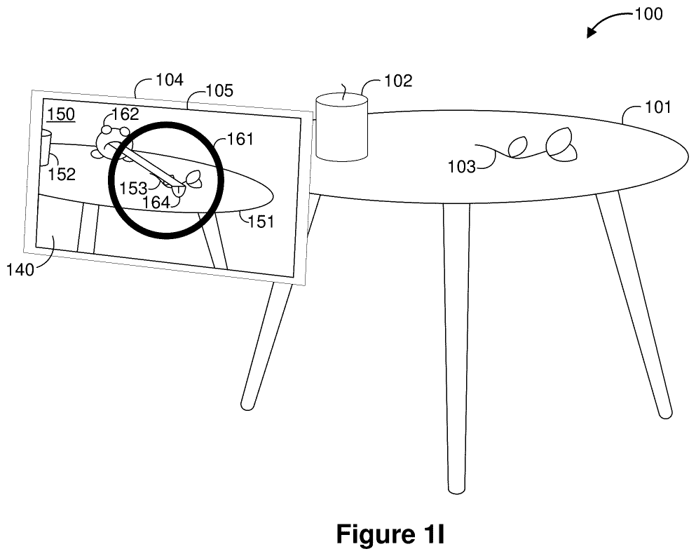

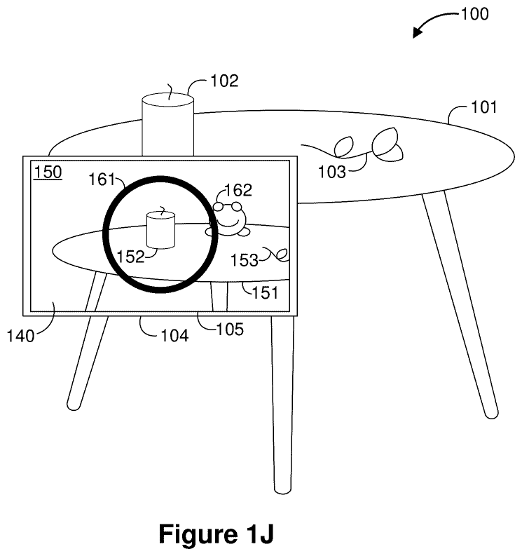

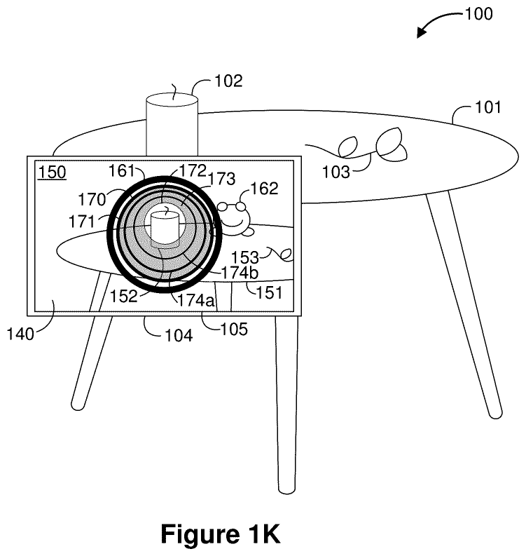

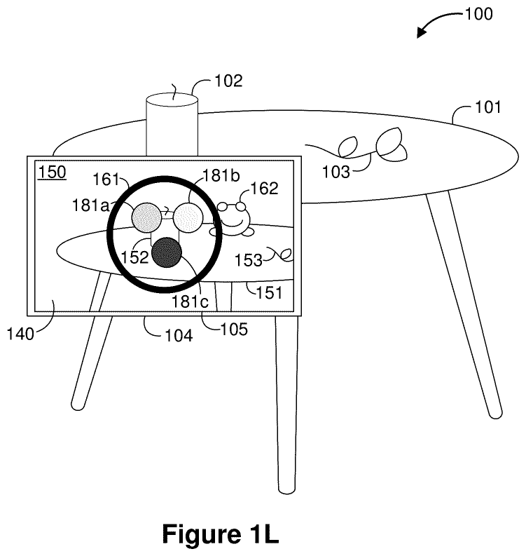

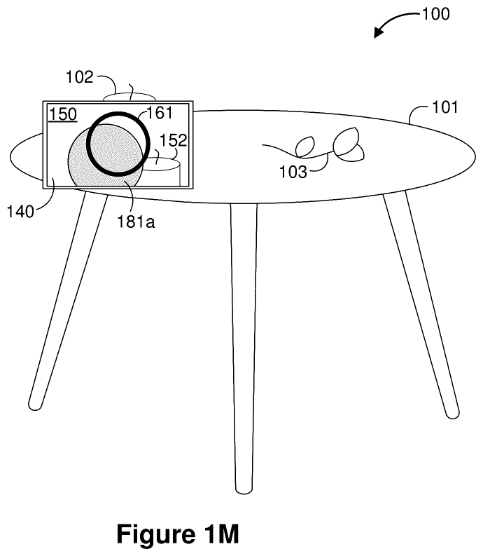

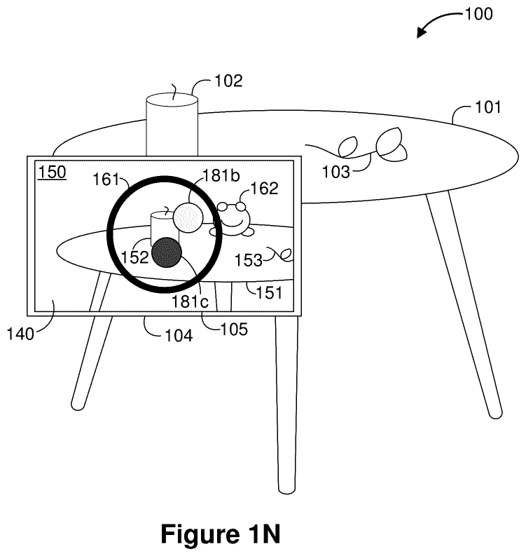

FIGS. 1A-IN illustrate a physical environment 100 at a series of times. The physical environment 100 includes a physical table 101, a physical candle 102 on the physical table 101, and a physical flower 103 on the physical table 101. The physical environment 100 includes a physical electronic device 104 (hereinafter “device 104”) including a display 105 via which the device 104 displays a mixed reality (MR) environment 140 based on the physical environment 100.

The MR environment 140 includes a physical environment representation 150 of a portion of the physical environment 100. In FIG. 1A, the physical environment representation 150 includes a table representation 151 of the physical table 101, a candle representation 152 of the physical candle 102, and a flower representation 153 of the physical flower. In various implementations, the device 104 includes a camera directed towards a portion of the physical environment 100 and the physical environment representation 150 displays at least a portion of an image captured by the camera. The MR environment 140 further includes one or more virtual objects overlaid on the physical environment representation 150. In particular, in FIG. 1A, the MR environment includes a virtual reticle 161 and a virtual frog 162.

The physical environment 100 is associated with a three-dimensional physical-environment coordinate system (represented by the axes 181) in which a point in the physical-environment coordinate system includes an x-coordinate, a y-coordinate, and a z-coordinate. The camera is associated with a three-dimensional camera coordinate system (represented by the axes 182) in which a point in the camera coordinate system includes an i-coordinate, a j-coordinate, and a k-coordinate. The k-axis of the camera coordinate system corresponds to the optical axis of the camera. The physical-environment coordinate system and the camera coordinate system are related by a transform based on the pose (e.g., the three-dimensional location and three-dimensional orientation) of the camera (and the device 103) in the physical-environment coordinate system. Thus, when the three-dimensional coordinates of a point in the physical-environment coordinate system and the pose of the device 103 in the physical-environment coordinate system are known, the three-dimensional coordinates of the point in the camera coordinate system can be determined.

Further, the display 105 of the device 104 is associated with a two-dimensional display coordinate system (represented by the axes 183) in which a point in the display coordinate system includes a u-coordinate and a v-coordinate. The camera coordinate system and the display coordinate system are related by a transform based on the intrinsic parameters of the camera. Thus, when the three-dimensional coordinates of a point in the camera coordinate system and the intrinsic parameters of the camera are known, the two-dimensional coordinates of the point in the display coordinate system can be determined. In various implementations, the i-axis is parallel to the u-axis and the j-axis is parallel to the v-axis.

In various implementations, a representation of a physical object may be displayed at a location on the display 105 corresponding to the location of the physical object in the physical environment 100. For example, in FIG. 1A, the candle representation 152 is displayed at a location on the display 105 corresponding to the location in the physical environment of the physical candle 102. Similarly, a virtual object may be displayed at a location on the display 105 corresponding to a location in the physical environment 100. For example, in FIG. 1A, the virtual frog 162 is displayed at a location on the display 104 corresponding to a location in the physical environment 100 on the physical table 101. Because the location on the display is related to the location in the physical environment using a transform based on the pose of the device 104, as the device 104 moves in the physical environment 100, the location on the display 105 of the candle representation 152 changes. Similarly, as the device 104 moves, the device 104 corresponding changes the location on the display 105 of the virtual frog 162 such that it appears to maintain its location in the physical environment 100 on the physical table 101. A virtual object that, in response to movement of the device 104, changes location on the display 105 to maintain its appearance at the same location in the physical environment 100 may be referred to as a “world-locked” virtual object.

To render a world-locked virtual object, the device 104 determines one or more sets of three-dimensional coordinates in the physical-environment coordinate system for the virtual object (e.g., a set of three-dimensional coordinates in the physical-environment coordinate system for each vertex of the virtual object). The device 104 transforms the one or more sets of three-dimensional coordinates in the physical-environment coordinate system into one or more sets of three-dimensional coordinates in the camera coordinate system using a transform based on the pose of the device 104. The device 104 transforms the one or more sets of three-dimensional coordinates in the camera coordinate system into one or more sets of two-dimensional coordinates in the display coordinate system using a transform based on the intrinsic parameters of the camera. Finally, the device 104 renders the virtual object on the display 105 using the two-dimensional coordinates in the display coordinate system.

A virtual object that, in response to movement of the device 104, maintains its location on the display 105 may be referred to as a “display-locked” virtual object (or a “device-locked” virtual object). For example, in FIG. 1A, the virtual reticle 161 is displayed at a location on the display 105 that does not change in response to movement of the device 104.

To render a display-locked virtual object, the device 104 determines one or more sets of two-dimensional coordinates in the display coordinate system for the virtual object (e.g., a set of two-dimensional coordinates in the display coordinate system for each vertex (or pixel) of the virtual object). Then, the device 104 renders the virtual object on the display 105 using the two-dimensional coordinates in the display coordinate system.

FIG. 1A illustrates the physical environment 100 at a first time. At the first time, the device 104 is at a first device location and has a first device orientation in the physical environment 100.

FIG. 1B illustrates the physical environment 100 at a second time subsequent to the first time. At the second time, the device 104 is at a second device location and has the first device orientation in the physical environment 100. Thus, between the first time and the second time, the device 104 moves from the first device location to the second device location. In response to this motion, the display-locked virtual reticle 161 has not changed its location on the display 105, but the world-locked virtual frog 162 has changed its location on the display 105.

FIG. 1C illustrates the physical environment 100 at a third time subsequent to the second time. At the third time, the device 104 is at the second device location and has the first device orientation in the physical environment 100. Between the first time and the second time, the device 104 determines that one or more tunnel display criteria have been satisfied.

In various implementations, at least one of the tunnel display criteria is satisfied when a physical object is detected at a physical object location in the physical-environment coordinate system. In various implementations, at least one of the tunnel display criteria is satisfied when a spatial relationship between the device 104 and the physical object satisfy one or more spatial-relationship criteria. In various implementations, at least one of the tunnel display criteria is satisfied when at least a threshold percentage of the representation of the physical object is within the virtual reticle 161. In various implementations, at least one of the tunnel display criteria is satisfied when another of the tunnel display criteria is satisfied for at least a threshold amount of time.

For example, between the second time and the third time, the device 104 determines that a first tunnel display criterion is satisfied by detection of the physical flower 103 at a flower location in the physical-environment coordinate system. Further, the device 104 determines that a second tunnel display criterion is satisfied by a determination that the device 104 is within a threshold distance of the physical flower 103. Further, the device 104 determines that a third tunnel display criterion is satisfied by a determination that the flower representation 153 is within the virtual reticle 161 for a threshold amount of time.

In response to determining that the tunnel display criteria have been satisfied, the device 104 display a virtual tunnel 170 in the MR environment 140. The virtual tunnel 170 includes a first end 171 and a second end 172. The first end 171 and second end 172 are connected by a tubular sleeve 173. Between the first end 171 and the second end 172, at various locations on the sleeve 173, are a plurality of rings 174a-174b. In various implementations, the tunnel includes the first end 171, the second end 172, and the plurality of rings 174a-174b without including the sleeve 173.

The first end 171 is a display-locked virtual object displayed on the display 105 at a first-end location in the display coordinate system and the second end 172 is a world-locked virtual object displayed on the display 105 at a second-end location in the display coordinate system corresponding to a second-end location in the physical-environment coordinate system surrounding the flower location. In various implementations, the plurality of rings 174a-174b are displayed on the display 105 at ring locations in the display coordinate system determined by interpolating between the first-end location in the display coordinate system and the second-end location in the display coordinate system.

The first-end location in the display coordinate system corresponds to a first-end location in the physical-environment coordinate system. In various implementations, the plurality of rings 174a-174b are displayed on the display 105 at ring locations in the display coordinate system determined by interpolating between the first-end location in the physical-environment coordinate system and the second-end location in the physical-environment coordinate system to determine ring locations in the physical-environment coordinate system which are transformed into ring locations in the display coordinate system.

In various implementations, the interpolation is a linear interpolation, resulting in a virtual tunnel 170 which is straight. In various implementations, the interpolation is a non-linear interpolation resulting in a virtual tunnel 170 which is curved or arcuate.

FIG. 1D illustrates the physical environment 100 at a fourth time subsequent to the third time. At the fourth time, the device 104 is at the first device location and has the first device orientation in the physical environment 100. Thus, between the third time and the fourth time, the device 104 moves from the second device location to the first device location. In response to this motion, the display-locked first end 171 of the virtual tunnel 170 has not changed its location on the display 105, but the world-locked second end 172 of the virtual tunnel 170 has changed its location on the display 105 so as to maintain its appearance at the location of the physical flower 103 surrounding the flower representation 153 which has also changed its location on the display 105. Further, for the plurality of rings 174a-174b, the ring locations in the display coordinate system are redetermined based on either the updated second-end location in the display coordinate system or the updated first-end location in the physical-environment coordinate system.

FIG. 1E illustrates the physical environment 100 at a fifth time subsequent to the fourth time. At the fifth time, the device 104 is at a third device location and has the first device orientation in the physical environment 100. Thus, between the fourth time and the fifth time, the device 104 moves from the first device location to the third device location. In response to this motion, the display-locked first end 171 of the virtual tunnel 170 has not changed its location on the display 105, but the world-locked second end 172 of the virtual tunnel 170 has changed its location in the display coordinate system to a location off the display 105. Further, for the plurality of rings 174a-174b, the ring locations in the display coordinate system are redetermined based on either the updated second-end location in the display coordinate system or the updated first-end location in the physical-environment coordinate system.

FIG. 1F illustrates the physical environment 100 at a sixth time subsequent to the fifth time. At the sixth time, the device 104 is at the third device location and has a second device orientation in the physical environment 100. Between the fifth time and the sixth time, the device 104 determines that one or more tunnel removal criteria have been satisfied.

In various implementations, at least one of the tunnel removal criteria is satisfied when a spatial relationship between the device 104 and the physical object satisfy one or more spatial-relationship criteria. In various implementations, at least one of the tunnel removal criteria is satisfied when the representation of the physical object is no longer displayed in the MR environment 140. In various implementations, at least one of the tunnel removal criteria is satisfied when another of the tunnel display criteria is satisfied for at least a threshold amount of time.

For example, between the fifth time and the sixth time, the device 104 determines that a first tunnel removal criterion is satisfied by a determination that the device 104 is at least a threshold distance away from the physical flower 103. Further, the device 104 determines that a second tunnel display criterion is satisfied by a determination that flower representation 153 is no longer displayed in the MR environment 140. In response to determining that the tunnel removal criteria have been satisfied, the device 104 ceases to display the virtual tunnel 170 in the MR environment 140.

FIG. 1G illustrates the physical environment 100 at a seventh time subsequent to the sixth time. At the seventh time, the device 104 is at a fourth device location and has the second device orientation in the physical environment 100.

FIG. 1H illustrates the physical environment 100 at an eighth time subsequent to the seventh time. At the eighth time, the device is at the fourth device location and has the second device orientation in the physical environment 100. Between the seventh time and the eighth time, the device 104 determines that one or more tongue display criteria have been satisfied.

In various implementations, at least one of the tongue display criteria is satisfied when a spatial relationship between the device 104 and the virtual frog 162 satisfy one or more spatial-relationship criteria. In various implementations, at least one of the tongue display criteria is satisfied when a random number is generated meeting one or more random number criteria.

For example, between the seventh time and the eighth time, the device 104 determines that a first tongue display criterion is satisfied by a determination that the device 104 is within a threshold distance of the virtual frog 162. Further, the device 104 determines that a second tunnel display criterion is satisfied by generating a random number between zero and one that is less than a threshold.

In response to determining that the tongue display criteria have been satisfied, the device 104 displays a virtual tongue 163 in the MR environment 140. The virtual tongue 163 includes a virtual tip 164 at a first end and is attached to the mouth of the virtual frog 162 at a second end.

The virtual tip 164 is a display-locked virtual object displayed on the display 105 at a tip location in the display coordinate system and the body of the virtual frog 162 is a world-locked virtual object displayed on the display 105 at a frog location in the display coordinate system corresponding to a frog location in the physical-environment coordinate system.

Between the seventh time and the eighth time, the device 104 determines that one or more tunnel display criteria have not been satisfied. In various implementations, the tunnel display criteria includes a criterion that is satisfied when the virtual tongue 163 is not displayed. For example, although the device 104 determines that a first tunnel display criterion is satisfied by detection of the physical candle 102 at a candle location in the physical-environment coordinate system, that a second tunnel display criterion is satisfied by a determination that the device 104 is within a threshold distance of the physical candle 102, and that a third tunnel display criterion is satisfied by a determination that the flower representation 152 is within the virtual reticle 161 for a threshold amount of time, the device 104 determines that a fourth tunnel display criterion is not satisfied because the virtual tongue 163 is displayed.

FIG. 1I illustrates the physical environment 100 at a ninth time subsequent to the eighth time. At the ninth time, the device 104 is at the second device location and has the first device orientation in the physical environment 100. Thus, between the eighth time and the ninth time, the device 104 moves from the fourth device location to the second device location. In response to this motion, the display-locked virtual tip 164 has not changed its location on the display 105, but the world-locked body of the virtual frog 162 has changed its location on the display 105.

FIG. 1J illustrates the physical environment 100 at a tenth time subsequent to the ninth time. At the tenth time, the device 104 is at the fourth device location and has the second device orientation in the physical environment 100. Thus, between the ninth time and the tenth time, the device 104 moves from the second device location to the fourth device location. Further, between the ninth time and the tenth time, the device 104 determines that one or more tongue removal criteria have been satisfied.

In various implementations, at least one of the tongue removal criteria is satisfied when a spatial relationship between the device 104 and the virtual frog 162 satisfy one or more spatial-relationship criteria. In various implementations, at least one of the tongue removal criteria is satisfied when the virtual tongue 163 has been displayed for at least a threshold amount of time. In various implementations, at least one of the tongue removal criteria is satisfied when a user performs a touch gesture on the display 105 at the location of virtual tip 164. In various implementations, at least one of the tongue removal criteria is satisfied when a user shakes the device 104.

In response to determining that the tongue removal criteria have been satisfied, the device 104 ceases display of the virtual tongue 163.

FIG. 1K illustrates the physical environment 100 at an eleventh time subsequent to the tenth time. At the eleventh time, the device 104 is at the fourth device location and has the second device orientation in the physical environment 100. Between the tenth time and the eleventh time, the device 104 determines that the one or more tunnel display criteria have been satisfied. Thus, at the eleventh time, the device 104 displays the virtual tunnel 170 in the MR environment 140.

FIG. 1L illustrates the physical environment 100 at a twelfth time subsequent to the eleventh time. At the twelfth time, the device 104 is at the fourth device location and the has second device orientation in the physical environment 100. Between the eleventh time and the twelfth time, the device 104 determines that one or more tunnel transformation criteria have been satisfied.

In various implementations, at least one of the tunnel transformation criteria is satisfied when a spatial relationship between the device 104 and the physical object satisfy one or more spatial-relationship criteria. In various implementations, at least one of the tunnel transformation criteria is satisfied when the virtual tunnel 170 is displayed for at least a threshold amount of time. In various implementations, at least one of the tunnel transformation criteria is satisfied when a user performs a touch gesture on the display 105 at the location of representation of the physical object.

In response to determining that the tunnel transformation criteria have been satisfied, the device 104 transforms the virtual tunnel 170 into a plurality of virtual orbs 181a-181c. In various implementations, the transformation of the virtual tunnel 170 into the plurality of virtual orbs 181a-181c is an animation. For example, in various implementations, one or more of the first end 171, second end 172, and the plurality of rings 174a-174b transform into respective ones of the plurality of virtual orbs 181a-181c. Each of the plurality of virtual orbs 181a-181c is a world-locked virtual object.

FIG. 1M illustrates the physical environment at a thirteenth time subsequent to the twelfth time. At the thirteenth time, the device 104 is at a fifth device location and has the second device orientation in the physical environment 100. Between the twelfth time and the thirteenth time, the device 104 moves from the fourth device location to the fifth device location.

FIG. 1N illustrates the physical environment at a fourteenth time subsequent to the thirteenth time. At the fourteenth time, the device 104 is at the fourth device location and has the second device orientation in the physical environment 100. Between the thirteenth time and the fourteenth time, the device 104 moves from the fifth device location to the fourth device location. Further, between the thirteenth time and the fourteenth time, the device 104 determines that one or more orb collection criteria have been satisfied.

In various implementations, at least one of the orb collection criteria is satisfied when a spatial relationship between the device 104 and a virtual orb satisfy one or more spatial-relationship criteria. In particular, in various implementations, at least one of the orb collection criteria is satisfied when the device 104 contacts the virtual orb in the physical-environment coordinate system. In various implementations, at least one of the orb collection criteria is satisfied when the virtual orb is displayed for at least a threshold amount of time. In various implementations, at least one of the orb collection criteria is satisfied when a user performs a touch gesture on the display 105 at the location of virtual orb.

In response to determining that the orb collection criteria have been satisfied with respect to the first virtual orb 181a, e.g., that the device 104 contacts the first virtual orb 181a, the device 104 ceases to display the first virtual orb 181a. Further, in various implementations, the device 104 stores an indication that the first virtual orb 181a has been collection. In various implementations, when the device 104 stores an indication that the first virtual orb 181a has been collected, a user can access information associated with the first virtual orb 181a which may include information regarding the physical object detected to result in display of the virtual tunnel 170. For example, in various implementations, the information associated with the virtual 181a includes information regarding candles, fire, oxidation chemistry, or other information related to the physical candle 102.

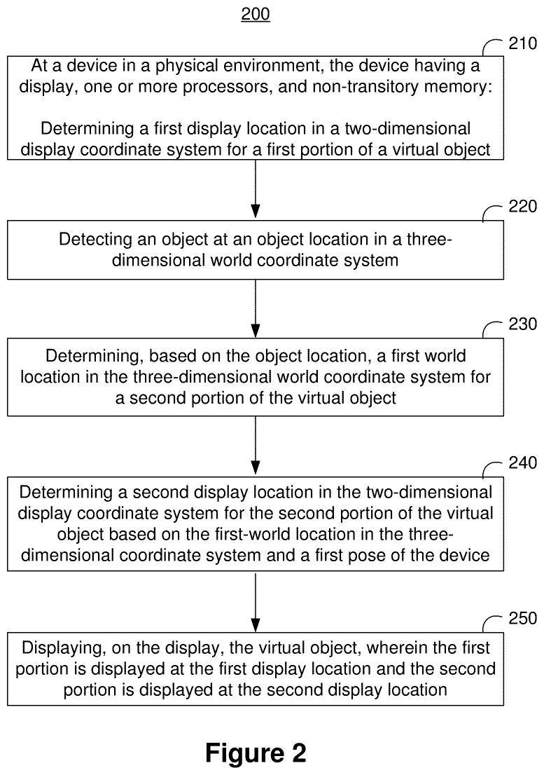

FIG. 2 is a flowchart representation of a method 200 of displaying a virtual object in accordance with some implementations. In various implementations, the method 200 is performed by a device in a physical environment. In various implementations, the method 200 is performed by a device including a display, one or more processors, and non-transitory memory. In some implementations, the method 200 is performed by processing logic, including hardware, firmware, software, or a combination thereof. In some implementations, the method 300 is performed by a processor executing instructions (e.g., code) stored in a non-transitory computer-readable medium (e.g., a memory).

The method 200 begins, in block 210, with the device determining a display location in a two-dimensional display coordinate system for a first portion of a virtual object. For example, in FIG. 1C, the device 104 determines the display location for the first end 171 of the virtual tunnel 170. As another example, in FIG. 1H, the device 104 determines the display location for the virtual tip 164 of the virtual tongue 163.

The method 200 continues, in block 220, with the device detecting an object at an object location in a three-dimensional world coordinate system. In various implementations, the three-dimensional world coordinate system is a coordinate system of the physical environment. In various implementations, detecting the object includes detecting a real object. For example, in FIG. 1C, the device 104 detects the physical flower 103. In various implementations, detecting the real object includes detecting the real object in an image of the physical environment. In various implementations, detecting the object includes detecting another virtual object. For example, in FIG. 1H, the device 104 detects the virtual frog 162.

The method 200 continues, in block 230, with the device determining, based on the object location, a first world location in the three-dimensional coordinate system for a second portion of the virtual object. In various implementations, the first world location is within a threshold distance of the object location. In various implementations, the first world location surrounds the object location. For example, in FIG. 1C, the second end 172 of the virtual tunnel 172 is at a display location corresponding to a first world location surrounding the physical flower 103. In various implementations, determining the first world location in the three-dimensional world system includes determining one or more sets of three-dimensional coordinates in the three-dimensional world coordinate system. For example, in various implementations, the one or more sets of three-dimensional coordinates include locations of one or more vertices of the virtual object.

The method 200 continues, in block 240, with the device determining a second display location in the two-dimensional display coordinate system for the second portion of the virtual object based on the first world-location in the three-dimensional world coordinate system and a first pose of the device. In various implementations, determining the second display location includes transforming the first world location into a location in a three-dimensional camera coordinate system of a camera of the device based on the pose of the device and transforming the location in the three-dimensional camera coordinate system to the second display location based on intrinsics of the camera.

The method 200 continues, in block 250, with the device displaying, on the display, the virtual object, wherein the first portion is displayed at the first display location and the second portion is displayed at the second display location. For example, in FIG. 1C, the first end 171 is displayed at a first display location and the second end 172 is displayed at a second display location. As another example, in FIG. 1H, the virtual tip 164 is displayed at a first display location and the other end of the virtual tongue 163 is displayed at a second display location of the virtual frog 162.

In various implementations, the method 200 includes determining a third display location in the two-dimensional display coordinate system for the second portion of the virtual object based on the first world location in the three-dimensional world coordinate system and a second pose of the device and displaying, on the display, the virtual object, wherein the first portion is displayed at the first display location and the second portion is displayed at the third display location. For example, in FIG. 1D, the first end 171 is displayed at the first display location (e.g., the same location as in FIG. 1C) and the second end 172 is displayed at a third display location (e.g., a different location than in FIG. 1C) based on movement of the device 104.

In various implementations, displaying the virtual object includes displaying an animation of the virtual object extending between the first display location and the second display location. For example, in FIG. 1C, in various implementations, the second end 172 moves from the first display location to the second display location. As another example, in FIG. 1H, in various implementations, the virtual tip 164 moves from the second display location to the first display location.

In various implementations, displaying the virtual object is performed in response to determining that one or more display criteria are satisfied. For example, in FIG. 1C, the virtual tunnel 170 is displayed in response to detecting the physical flower 103. In various implementations, at least one of the one or more display criteria is satisfied when a spatial relationship between the device and the object satisfies one or more spatial-relationship criteria. For example, in FIG. 1C, the virtual tunnel 170 is displayed in response to the orientation of the device 104 with respect to the physical flower 103 placing the representation of the physical flower 153 in the virtual reticle 161.

In various implementations, the method 200 further includes transforming the virtual object include a plurality of virtual sub-objects and, in response to determining that one or more collection criteria are satisfied for a particular virtual sub-object of the plurality of virtual sub-objects, ceasing to display the virtual sub-object. In various implementations, at least one of the one or more collection criteria is satisfied when a spatial relationship between the device and the virtual sub-object satisfies one or more spatial-relationship criteria. In various implementations, at least one of the one or more spatial-relationship criteria is satisfied when the device contacts the virtual sub-object. For example, in FIG. 1L, the virtual tunnel 170 is transformed into a plurality of virtual orbs 181a-181c. In FIG. 1M, the device 104 determines that collection criteria for the first virtual orb 181a are satisfied. In FIG. 1N, the first virtual orb 181a is not displayed.

In various implementations, the method 200 includes determining a third display location in the two-dimensional display coordinate system for a third portion of the virtual object, wherein the third portion is display at the third display location. For example, in FIG. 1C, the device displays the plurality of rings 174a-174b at a third display location. In various implementations, determining the third display location is based on an interpolation between the first display location and the second display location. In various implementations, determining the third display location includes determining a second world location in the three-dimensional world coordinate system for the first portion and determining the third display location is based on an interpolation between the second world location and the first world location.

In various implementations, virtual object is a continuous between the first portion, the third portion, and the second portion. For example, in FIG. 1C, when the virtual tunnel 170 includes the tubular sleeve 173, the virtual tunnel is continuous. As another example, in FIG. 1H, the virtual tongue is continuous. In various implementations, the virtual object includes a plurality of discrete segments including the first portion, the third portion, and the second portion. For example, in FIG. 1C, when the virtual tunnel 170 does not include the tubular sleeve 173, the virtual tunnel includes a plurality of discrete segments, e.g., the first end 171, the second end 172, and the plurality of rings 174a-174b.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device with a display, one or more processors, and non-transitory memory:
determining a first display location in a two-dimensional display coordinate system for a first portion of a virtual object;
detecting an object at an object location in a three-dimensional world coordinate system;
determining, based on the object location, a first world location in the three-dimensional world coordinate system for a second portion of the virtual object;
determining a second display location in the two-dimensional display coordinate system for the second portion of the virtual object based on the first world-location in the three-dimensional world coordinate system and a first pose of the device; and
displaying, on the display, the virtual object, wherein the first portion is displayed at the first display location and the second portion is displayed at the second display location.

2. The method of claim 1, further comprising:
determining a third display location in the two-dimensional display coordinate system for the second portion of the virtual object based on the first world location in the three-dimensional world coordinate system and a second pose of the device; and
displaying, on the display, the virtual object, wherein the first portion is displayed at the first display location and the second portion is displayed at the third display location.

3. The method of claim 1, wherein detecting the object includes detecting a real object.

4. The method of claim 3, wherein detecting the real object includes detecting the real object in an image of a physical environment.

5. The method of claim 1, wherein detecting the object includes detecting another virtual object.

6. The method of claim 1, wherein the first world location is within a threshold distance of the object location.

7. The method of claim 1, wherein the first world location surrounds the object location.

8. The method of claim 1, wherein displaying the virtual object includes displaying an animation of the virtual object extending between the first display location and the second display location.

9. The method of claim 1, wherein displaying the virtual object is performed in response to determining that one or more display criteria are satisfied.

10. The method of claim 9, wherein at least one of the one or more display criteria is satisfied when a spatial relationship between the device and the object satisfies one or more spatial-relationship criteria.

11. The method of claim 1, further comprising:
transforming the virtual object include a plurality of virtual sub-objects; and
in response to determining that one or more collection criteria are satisfied for a particular virtual sub-object of the plurality of virtual sub-objects, ceasing to display the virtual sub-object.

12. The method of claim 11, wherein at least one of the one or more collection criteria is satisfied when a spatial relationship between the device and the virtual sub-object satisfies one or more spatial-relationship criteria.

13. The method of claim 12, wherein at least one of the one or more spatial-relationship criteria is satisfied when the device contacts the virtual sub-object.

14. The method of claim 1, further comprising determining a third display location in the two-dimensional display coordinate system for a third portion of the virtual object, wherein the third portion is displayed at the third display location.

15. The method of claim 14, wherein determining the third display location is based on an interpolation between the first display location and the second display location.

16. The method of claim 14, wherein determining the third display location includes determining a second world location in the three-dimensional world coordinate system for the first portion and determining the third display location is based on an interpolation between the second world location and the first world location.

17. The method of claim 14, wherein the virtual object is a continuous between the first portion, the third portion, and the second portion.

18. The method of claim 14, wherein the virtual object includes a plurality of discrete segments including the first portion, the third portion, and the second portion.

19. A device comprising:
a display;
non-transitory memory; and
one or more processors to:
determine a first display location in a two-dimensional display coordinate system for a first portion of a virtual object;
detect an object at an object location in a three-dimensional world coordinate system;
determine, based on the object location, a first world location in the three-dimensional world coordinate system for a second portion of the virtual object;
determine a second display location in the two-dimensional display coordinate system for the second portion of the virtual object based on the first world-location in the three-dimensional world coordinate system and a first pose of the device; and
display, on the display, the virtual object, wherein the first portion is displayed at the first display location and the second portion is displayed at the second display location.

20. A non-transitory computer-readable medium having instructions thereon which, when executed by a device including a processor and a display, cause the device to:
determine a first display location in a two-dimensional display coordinate system for a first portion of a virtual object;
detect an object at an object location in a three-dimensional world coordinate system;
determine, based on the object location, a first world location in the three-dimensional world coordinate system for a second portion of the virtual object;
determine a second display location in the two-dimensional display coordinate system for the second portion of the virtual object based on the first world-location in the three-dimensional world coordinate system and a first pose of the device; and
display, on the display, the virtual object, wherein the first portion is displayed at the first display location and the second portion is displayed at the second display location.
